(19) United States
(12) Patent Application Publication
(10) Pub. No.: US 2015/0029564 A1
(43) Pub. Date: Jan. 29, 2015

(54) IMAGE FORMING APPARATUS AND IMAGE FORMING METHOD

(71) Applicant: KYOCERA Document Solutions Inc., Osaka (JP)

(72) Inventor: Hiroki SAKANE, Osaka (JP)

(73) Assignee: KYOCERA DOCUMENT SOLUTIONS INC., Osaka (JP)

(21) Appl. No.: 14/336,365

(22) Filed: Jul. 21, 2014

(30) Foreign Application Priority Data
Jul. 26, 2013 (JP) 2013-156134

(51) Int. Cl. G03F 3/08

(52) U.S. Cl. CPC G03G 15/50; G03G 15/01
USPC 358/518

(57) ABSTRACT

A image forming apparatus includes a color conversion unit, a toner-level-specifying unit and a color-conversion-properties-setting unit. The color conversion unit executes a color conversion process for converting input image data to image data for each color of a plurality of color toners. The toner-level-specifying unit specifies the levels of the plurality of color toners. The color-conversion-properties-setting unit causes adjusted input/output properties to be set in the color conversion unit as input/output properties for the color conversion process when the input image data has a saturation that is less than a predetermined value, the adjusted input/output properties being such that the amount used of the color toner having the lowest level is less than in predetermined standard input/output properties.

### CROSS-REFERENCE TO RELATED APPLICATIONS

This application is based upon and claims the benefit of priority from the corresponding Japanese Patent Application 2013-156134, filed on Jul. 26, 2013, the entire contents of which are incorporated herein by reference.

### BACKGROUND OF THE INVENTION

The present disclosure relates to an image forming apparatus and image forming method.

Electrophotographic color image forming apparatus use a plurality of toners of different colors to form and print color images. A typical color image forming apparatus uses four colors of toner: cyan (C), magenta (M), yellow (Y), and black (K).

Because the amount of each color of toner consumed will vary according to the image being printed, it almost never occurs that the toner in the toner cartridges for the various colors runs out at the same time, and, when one color of toner runs out, the toner cartridge for that color is replaced with a new toner cartridge filled with toner. Without a new toner cartridge for the color in question, the toner cartridge cannot be replaced, making it impossible to continue color printing.

Thus, in certain color image forming apparatus, when the toner for one color runs out, printing is performed using the toner for the other colors.

In other color image forming apparatus, when the toner level runs low, the amount used of the toner whose level is running low is reduced when printing.

However, if printing is performed using the toner for the other colors when the toner for one color runs out, as in the case of the technology described above, the coloration of the printed image ends up being completely different from what it should be.

In addition, in the technology described above, when the toner level runs low, the amount used of the toner whose level is running low is reduced, but, because the amount of toner used is uniformly reduced so that image quality is maintained and there is almost no effect as viewed by the unaided eye of a user, there is little reduction in the amount of toner used.

### SUMMARY OF THE INVENTION

The image forming apparatus according to the present disclosure is provided with a color conversion unit configured to a color conversion process in which input image data is converted to image data for colors of each of a plurality of color toners, a color-conversion-properties-setting unit for setting input/output properties for the color conversion process, and a toner-level-specifying unit for specifying the levels of each of the plurality of color toners. When the input image data has a saturation that is less than a predetermined value, the color-conversion-properties-setting unit sets adjusted input/output properties as the input/output properties for the color conversion process, the adjusted input/output properties being such that the amount used of the color toner having the lowest level is less than the amount used of the same color toner used in predetermined standard input/output properties in the color conversion unit.

Further features and advantages of the present disclosure will become apparent from the description of embodiments given below.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a side view of part of the internal mechanical configuration of an image forming apparatus according to an embodiment of the present disclosure;

FIG. 2 is a block diagram of an example of the electrical configuration of the image forming apparatus shown in FIG. 1; and

FIG. 3 is a flow chart illustrating the operation of the image forming apparatus shown in FIG. 1 and FIG. 2.

### DETAILED DESCRIPTION OF THE EMBODIMENTS

An embodiment of the present disclosure will now be described with reference to the drawings.

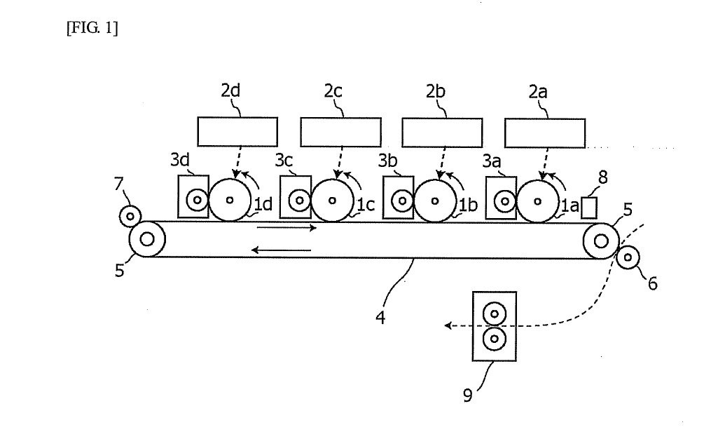

FIG. 1 is a side view of part of the internal mechanical configuration of an image forming apparatus according to an embodiment of the present disclosure. The image forming apparatus is a device having an electrophotographic printing function, such as a printer, fax machine, photocopier, or multifunction device.

The image forming apparatus according to the present embodiment includes a tandem-format color developing device. The color developing device includes photosensitive drums 1a-1d, exposure devices 2a-2d, and developing devices 3a-3d. The photosensitive drums 1a-1d are photosensitive units for four colors: cyan, magenta, yellow, and black. The exposure devices 2a-2d are devices for irradiating the photosensitive drums 1a-1d with laser light in order to form latent electrostatic images. The exposure devices 2a-2d are laser scanning units including laser diodes serving as laser light sources, and optical elements (such as lenses, mirrors, polygonal mirrors, etc.) for directing the laser light onto the photosensitive drums 1a-1d.

A static charger such as a scorotron, a cleaning device, a static eliminator, and the like are disposed around the photosensitive drums 1a-1d. The cleaning device removes the residual toner from the photosensitive drums 1a-1d after primary image transfer, and the static eliminator removes the charge from the photosensitive drums 1a-1d after primary image transfer.

The developing devices 3a-3d are equipped with toner cartridges filled with toner for each of the four colors of cyan, magenta, yellow, and black, and toner is provided from the toner cartridges to form a developer along with a carrier. The developing devices 3a-3d cause toner to cling to the latent electrostatic images on the photosensitive drums 1a-1d to form toner images.

Development of magenta is performed by the photosensitive drum 1a, the exposure device 2a, and the developing device 3a, development of cyan is performed by the photosensitive drum 1b, the exposure device 2b, and the developing device 3b, development of yellow is performed by the photosensitive drum 1c, the exposure device 2c, and the developing device 3c, and development of black is performed by the photosensitive drum 1d, the exposure device 2d, and the developing device 3d.

An intermediate image transfer belt 4 constitutes a loop-shaped image carrier unit that contacts the photosensitive drums 1a-1d and performs primary image transfer of the toner images on the photosensitive drums 1a-1d. The intermediate image transfer belt 4 is slung around drive rollers 5, and is driven around by driving force from the drive rollers 5 in a direction traveling from the position of contact with the photosensitive drum 1d to a position of contact with the photosensitive drum 1a.

An image transfer roller 6 brings delivered paper into contact with the intermediate image transfer belt 4, effecting secondary image transfer of the toner image on the intermediate image transfer belt 4 onto the paper. The paper onto which the toner image has been transferred is carried to a fuser unit 9, where the toner image is fused to the paper.

A roller 7 includes a cleaning brush that is brought into contact with the intermediate image transfer belt 4 to remove toner remaining on the intermediate image transfer belt 4 after transfer of the toner image to the paper.

A sensor 8 is used to adjust toner concentration, and directs a light beam upon the intermediate image transfer belt 4 and detects light reflecting therefrom. When adjusting toner concentration, the sensor 8 directs a light beam upon a predetermined area of the intermediate image transfer belt 4, detects reflected light (measurement light) from the light beam, and outputs an electrical signal according to the amount of light.

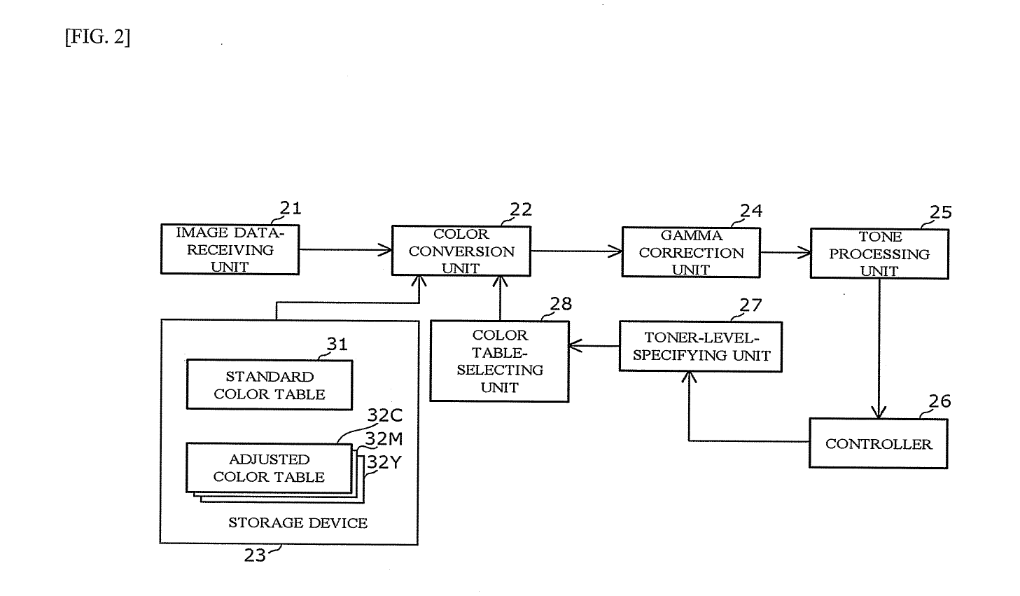

FIG. 2 is a block diagram of an example of the electrical configuration of the image forming apparatus shown in FIG. 1.

As shown in FIG. 2, the image forming apparatus includes an image data-receiving unit 21, a color conversion unit 22, a storage device 23, a gamma correction unit 24, a tone processing unit 25, and a controller 26.

The image data-receiving unit 21 forms image data (RGB data) from page description language (PDL) data or the like received from an external host device not shown in the drawings, and receives image data (RGB data) for document images read by a built-in scanner not shown in the drawings.

The color conversion unit 22 executes a color conversion process. In the color conversion process, input image data is converted to image data for colors of each of a plurality of color toners (i.e., toners other than black). Specifically, the color conversion unit 22 uses lookup tables in the storage device 23 to convert the RGB data to CMYK data corresponding to the toner colors CMYK.

The storage device 23 is nonvolatile memory that stores a standard color table 31 and adjusted color tables 32C, 32M, 32Y as lookup tables.

The standard color table 31 is a table for converting RGB data to CMYK data so that there is no change in color expression.

The adjusted color tables 32C, 32M, 32Y are tables of adjusted input/output properties from RGB to CMYK. In the present embodiment, the adjusted color table 32C is configured so that the adjusted input/output properties are such that the amount of cyan toner used is less than in predetermined standard input/output properties when the saturation of the input image data is less than a predetermined value. The adjusted color table 32M is configured so that the adjusted input/output properties are such that the amount of magenta toner used is less than in predetermined standard input/output properties when the saturation of the input image data is less than a predetermined value. The adjusted color table 32Y is configured so that the adjusted input/output properties are such that the amount of yellow toner used is less than in predetermined standard input/output properties when the saturation of the input image data is less than a predetermined value. The color reduction levels are set within ranges such that the changes in color resulting from the reduced toner amounts are acceptable to a user. These ranges are determined, for example, via experimentation.

The gamma correction unit 24 performs tone correction upon the image data for each color of CMYK.

The tone processing unit 25 performs a tone process, such as a screen process, upon the image data following tone correction.

The controller 26 controls the mechanism shown in FIG. 1 on the basis of the image data upon which the tone process has been performed, and performs electrophotographic printing of a color image based on the image. The controller 26 monitors the various parts of the mechanism shown in FIG. 1, as well as the toner levels of the toner cartridges for the various colors.

The toner-level-specifying unit 27 sends inquiries to the controller 26 to determine the levels of the plurality of color toners (in the present embodiment, CMY).

A color table-selecting unit 28 (color-conversion-properties-setting unit) sets the input/output properties for the color conversion process performed by the color conversion unit 22 in the color conversion unit 22. Specifically, the color table-selecting unit 28 selects one of the standard color table 31 and the adjusted color tables 32C, 32M, 32Y, and sets the selected color table as the lookup table used in the color conversion process in the color conversion unit 22.

If selecting one of the adjusted color tables 32C, 32M, 32Y, the color table-selecting unit 28 selects that color table out of the adjusted color tables 32C, 32M, 32Y that corresponds to the color toner having the lowest toner level as determined by the toner-level-specifying unit 27, and sets the selected color table in the color conversion unit 22 as the lookup table used for the color conversion process.

In the present embodiment, the color table-selecting unit 28 selects one of the standard color table 31 and the adjusted color tables 32C, 32M, 32Y (the adjusted color table for whichever of the colors CMY has the lowest level) according to the levels of the plurality of color toners.

Specifically, if the difference in level between any two of the plurality of color toners is greater than a predetermined threshold value, the color table-selecting unit 28 selects an adjusted color table 32i (i=C, M, Y) corresponding to the color having the lowest level, and sets the table in the color conversion unit 22; otherwise, the standard color table 31 is set in the color conversion unit 22.

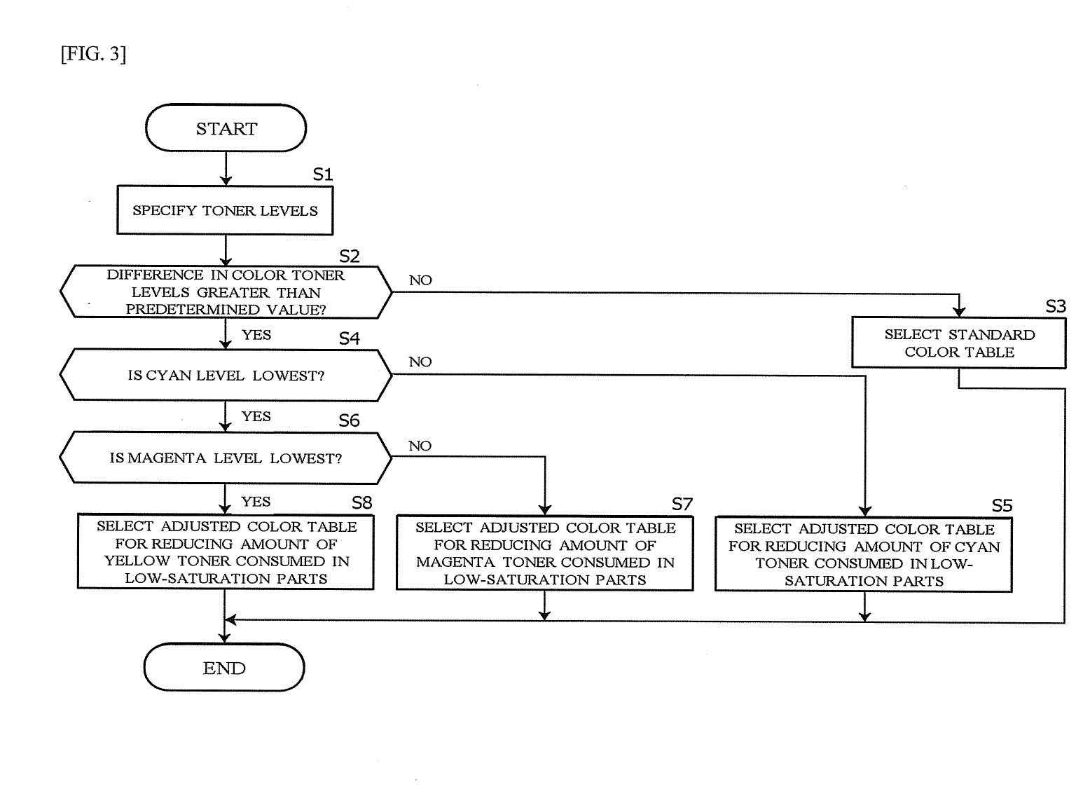

Next, the operation of the image forming apparatus will be described. FIG. 3 is a flow chart illustrating the operation of the image forming apparatus shown in FIG. 1 and FIG. 2.

For every instance of printing, when the image data-receiving unit 21 receives image data, the toner-level-specifying unit 27 specifies the current toner levels for each color (step S1).

Next, the color table-selecting unit 28 assesses whether the difference (in this case, at least one of the difference between the cyan toner level and the magenta toner level, the difference between the magenta toner level and the yellow toner level, and the difference between the yellow toner level and the cyan toner level) between two of the determined toner levels (in this case, the toner levels for the three colors CMY) is greater than a predetermined value (step S2).

If the difference in toner levels for any combination of two colors is not greater than the predetermined value (NO in step S2), the color table-selecting unit 28 selects the standard color table 31 and sets it in the color conversion unit 22 (step S3)

On the other hand, if the difference in toner levels between two colors is greater than the predetermined value (YES in step S2), and the color table-selecting unit 28 assesses whether the cyan toner level is lowest out of the toner levels for cyan, magenta, and yellow(step S4). If the cyan toner level is lowest out of the toner levels for cyan, magenta, and yellow (YES in step S4), the color table-selecting unit 28 selects the adjusted color table 32C and sets it in the color conversion unit 22 (step S5).

If the cyan toner level is not lowest out of the toner levels for cyan, magenta, and yellow (NO in step S4), he color table-selecting unit 28 assesses whether the magenta toner level is lowest out of the toner levels for cyan, magenta, and yellow (step S6). If the magenta toner level is lowest out of the toner levels for cyan, magenta, and yellow (YES in step S6), the color table-selecting unit 28 selects the adjusted color table 32M and sets it in the color conversion unit 22 (step S7).

If the magenta toner level is not lowest out of the toner levels for cyan, magenta, and yellow (NO in step S6), and the yellow toner level is lowest out of the toner levels for cyan, magenta, and yellow, the color table-selecting unit 28 selects the adjusted color table 32Y and sets it in the color conversion unit 22 (step S8).

Such an arrangement minimizes the amount consumed of color toner that is consumed more than the other colors.

In accordance with the present embodiment, as discussed above, the color conversion unit 22 executes a color conversion process for converting input image data to image data for each color of a plurality of color toners, and the toner-level-specifying unit 27 specifies the levels of the plurality of color toners. If the saturation of the input image data is less than a predetermined value, the color table-selecting unit 28 sets adjusted input/output properties such that the amount used of the color having the lowest toner level is less than in predetermined standard input/output properties in the color conversion unit 22 as the input/output properties for the color conversion process.

As a result, colors close to gray (i.e., colors of low saturation) are adjusted during color conversion, yielding a change in picture quality that is likely to be acceptable to a user and effectively reducing the amount of toner consumed for colors having low toner levels.

The embodiment described above is a preferred example of the present disclosure, but the present disclosure is not limited thereto, and various alterations or modifications may be made thereto to the extent that they do not depart from the gist of the present disclosure.

For example, in the embodiment described above, a configuration in which the color table-selecting unit 28 always selects the standard color table 31 if the total of the toner levels for the plurality of color toners is greater than a predetermined value, and selects a color table as described above if the total of the toner levels for the plurality of color toners is equal to or less than the predetermined value.

The present disclosure can be applied, for example, to a color image forming apparatus.

What is claimed is:

1. An image forming apparatus including:
a color conversion unit configured to execute a color conversion process in which input image data is converted to image data for colors of each of a plurality of color toners;
a toner-level-specifying unit configured to specify levels of the plurality of color toners; and
a color-conversion-properties-setting unit configured to cause adjusted input/output properties to be set in the color conversion unit as input/output properties for the color conversion process when the input image data has a saturation that is less than a predetermined value, the adjusted input/output properties being such that the amount used of the color toner having the lowest level is less than in predetermined standard input/output properties.

2. The image forming apparatus according to claim 1, wherein:
the color-conversion-properties-setting unit sets the standard input/output properties or the adjusted input/output properties as the input/output properties in the color conversion unit according to the levels of the plurality of color toners.

3. The image forming apparatus according to claim 2, wherein:
the color-conversion-properties-setting unit sets the adjusted input/output properties in the color conversion unit when the difference in levels between any two of the plurality of color toners is greater than a predetermined threshold value, and sets the standard input/output properties in the color conversion unit when the difference in levels between any two of the plurality of color toners is not greater than the predetermined threshold value.

4. The image forming apparatus according to claim 1, further including
an adjusted color table indicating adjusted input/output properties for each color of the plurality of color toners; and
a standard color table showing standard input/output properties,
wherein:
the color-conversion-properties-setting unit sets adjusted input/output properties based on the adjusted color table or standard input/output properties based on the standard color table as the input/output properties in the color conversion unit.

5. The image forming apparatus according to claim 1, wherein:
the color conversion unit converts input image data to image data for the four colors of cyan, magenta, yellow, and black; and
the plurality of color toners are cyan, magenta, and yellow.

6. An image forming method including:
executing a color conversion process for converting input image data to image data for each color of a plurality of color toners;
specifying levels of the plurality of color toners; and
setting adjusted input/output properties as input/output properties for the color conversion process when the input image data has a saturation that is less than a predetermined value, the adjusted input/output properties being such that the amount used of the color toner having the lowest level is less than in predetermined standard input/output properties.

7. The image forming method according to claim 6, wherein:
in the setting the adjusted input/output properties as input/output properties for the color conversion process, the standard input/output properties or the adjusted input/output properties are set as the input/output properties for the color conversion process according to the levels of the plurality of color toners.

8. The image forming method according to claim 7, wherein:
in the setting the adjusted input/output properties as the input/output properties for the color conversion process, the adjusted input/output properties are set as the input/output properties for the color conversion process when the difference in levels between any two of the plurality of color toners is greater than a predetermined threshold value, and the standard input/output properties are set as the input/output properties for the color conversion process when the difference in levels between any two of the plurality of color toners is not greater than the predetermined threshold value.

9. The image forming method according to claim 6, wherein:
the adjusted input/output properties based on an adjusted color table indicating adjusted input/output properties for each color of the plurality of color toners or standard input/output properties based on a standard color table are set as the input/output properties for the color conversion process.

10. The image forming method according to claim 6, wherein:
at the color conversion process, the input image data is converted into image data for the four colors of cyan, magenta, yellow, and black; and
the plurality of color toners are cyan, magenta, and yellow.
